(19) United States
(12) Patent Application Publication
(10) Pub. No.: US 2025/0365071 A1
(43) Pub. Date: Nov. 27, 2025

(54) OPTICAL FILTER CONTROL APPARATUS, OPTICAL RECEPTION APPARATUS, AND OPTICAL RECEPTION METHOD

(71) Applicant: NEC Corporation, Tokyo (JP)

(72) Inventor: Hidemi NOGUCHI, Tokyo (JP)

(73) Assignee: NEC Corporation, Tokyo (JP)

(21) Appl. No.: 19/203,480

(22) Filed: May 9, 2025

(30) Foreign Application Priority Data
May 27, 2024 (JP) 2024-085330

(51) Int. Cl. H04B 10/2507; H04B 10/2537

(52) U.S. Cl. CPC H04B 10/25073; H04B 10/2537

(57) ABSTRACT

An optical filter control apparatus according to the present disclosure includes: a compensation characteristic estimation unit configured to receive a received signal extracted from an optical signal that has passed through an optical filter provided in an optical transmission line and configured to transmit the optical signal having a predetermined frequency setting value, and estimate a compensation characteristic for compensating for waveform distortion due to a transmission path of the received signal; a frequency deviation estimation unit configured to estimate a frequency deviation between the frequency setting value and a reception frequency value acquired from the received signal; and a setting value calculation unit configured to calculate an optical filter setting value to be set in the optical filter by using the compensation characteristic adjusted based on the frequency deviation.

### INCORPORATION BY REFERENCE

This application is based upon and claims the benefit of priority from Japanese patent application No. 2024-85330, filed on May 27, 2024, the disclosure of which is incorporated herein in its entirety by reference.

### TECHNICAL FIELD

The present disclosure relates to an optical filter control apparatus, an optical reception apparatus, an optical transmission system, and an optical reception method.

### BACKGROUND ART

Japanese Unexamined Patent Application Publication No. 2000-269895 discloses an optical wavelength stabilization system for a tunable optical filter at a reception end of optical wavelength multiplexing communication. In this system, a transmission wavelength of the tunable optical filter is electrically controlled in response to ambient temperature fluctuation, so that the temperature fluctuation of the transmission wavelength is suppressed, and an optimum reception characteristic is obtained for an arbitrary wavelength signal subjected to optical wavelength multiplexing at a high density.

### SUMMARY

In response to a demand for a large capacity of an optical communication system, a transmission amount is dramatically increased by introduction of a digital coherent optical communication technology. Since the introduction of the digital coherent optical communication technology, equalization signal processing on a reception side by digital signal processing such as collectively compensating for wavelength dispersion accumulated in an optical transmission line on the reception side using a digital signal processor (DSP) has been adopted.

Complicated digital signal processing requires an increase in power of an optical reception apparatus even with the benefit of a state-of-the-art complementary metal-oxide-semiconductor (CMOS). Therefore, it is expected that efficiency gradually deteriorates if improving performance only by the optical reception apparatus on which the DSP is mounted. Therefore, it is desirable to optimize waveform distortion compensation for an optical signal in the entire optical communication system while utilizing the digital signal processing.

As one of the technologies, there is a method of reducing a load of the DSP by compensating for a part of waveform distortion compensated by the DSP in a light region. In a case where a part of the waveform distortion compensated by the DSP is offloaded to an optical filter provided in the optical transmission line, there is a problem that it is difficult to perform distortion compensation with high accuracy because an adjustment method for the optical filter is not established.

In view of the above-described problems, an example object of the present disclosure is to provide an optical filter control apparatus, an optical reception apparatus, an optical transmission system, and an optical reception method capable of adjusting an optical filter to implement optimization of waveform distortion compensation for an optical signal.

An optical filter control apparatus according to a first example aspect of the present disclosure includes: a compensation characteristic estimation unit configured to receive a received signal extracted from an optical signal that has passed through an optical filter provided in an optical transmission line and configured to transmit the optical signal having a predetermined frequency setting value, and estimate a compensation characteristic for compensating for waveform distortion due to a transmission path of the received signal; a frequency deviation estimation unit configured to estimate a frequency deviation between the frequency setting value and a reception frequency value acquired from the received signal; and a setting value calculation unit configured to calculate an optical filter setting value to be set in the optical filter by using the compensation characteristic adjusted based on the frequency deviation.

An optical reception apparatus according to a second example aspect of the present disclosure includes: an optical receiver configured to extract a received signal from an optical signal that has passed through an optical filter provided in an optical transmission line and configured to transmit the optical signal having a predetermined frequency setting value; a compensation characteristic estimation unit configured to estimate a compensation characteristic for compensating for waveform distortion due to a transmission path of the received signal; a frequency deviation estimation unit configured to estimate a frequency deviation between the frequency setting value and a reception frequency value acquired from the received signal; and a setting value calculation unit configured to calculate an optical filter setting value to be set in the optical filter by using the compensation characteristic adjusted based on the frequency deviation.

An optical transmission system according to a third example aspect of the present disclosure includes: an optical transmission apparatus; and an optical reception apparatus configured to receive an optical signal output from the optical transmission apparatus via an optical transmission line, in which the optical transmission line includes an optical filter that transmits the optical signal having a frequency setting value, and the optical reception apparatus includes: an optical receiver configured to extract a received signal from the optical signal that has passed through the optical filter; a compensation characteristic estimation unit configured to estimate a compensation characteristic for compensating for waveform distortion due to a transmission path of the received signal; a frequency deviation estimation unit configured to estimate a frequency deviation between the frequency setting value and a reception frequency value acquired from the received signal; and a setting value calculation unit configured to calculate an optical filter setting value to be set in the optical filter by using the compensation characteristic adjusted based on the frequency deviation.

An optical reception method according to a fourth example aspect of the present disclosure includes: extracting, by an optical receiver, a received signal from an optical signal that has passed through an optical filter provided in an optical transmission line and configured to transmit the optical signal having a predetermined frequency setting value; estimating, by a processor, a compensation characteristic for compensating for waveform distortion due to a transmission path of the received signal; estimating, by a frequency deviation estimation unit, a frequency deviation between the frequency setting value and a reception frequency value acquired from the received signal; and calculating, by a setting value calculation unit, an optical filter setting value to be set in the optical filter by using the compensation characteristic adjusted based on the frequency deviation.

An example advantage according to the above-described embodiments is to optimize waveform distortion compensation for an optical signal by adjusting the optical filter.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 schematically illustrates a communication system according to the present disclosure;

FIG. 2 schematically illustrates an optical filter control apparatus according to the present disclosure;

FIG. 3 is a block diagram illustrating a configuration of an optical communication system according to the present disclosure;

FIG. 4 is a diagram illustrating a configuration of a compensation characteristic estimation unit according to the present disclosure;

FIG. 5 illustrates an ideal spectrum of a received signal, an actually received signal spectrum, and an estimated transmission path compensation characteristic with reference to reception LO light of a light source on a reception side;

FIG. 6 illustrates an amplitude characteristic of an optical filter in a case where a notch filter is applied;

FIG. 7 illustrates an optical filter setting value set in the optical filter in a case where the notch filter is superimposed;

FIG. 8 illustrates a spectrum of a received signal received by an optical receiver;

FIG. 9 is a diagram for describing adjustment based on a frequency deviation of the transmission path compensation characteristic;

FIG. 10 is a flowchart for describing an optical reception method according to the present disclosure;

FIG. 11 is a diagram for describing a setting position for a reference frequency;

FIG. 12 is a flowchart for describing another example of the optical reception method according to the present disclosure;

FIG. 13 illustrates an amplitude characteristic of the optical filter in a case where a bandpass filter is applied;

FIG. 14 illustrates a spectrum of the received signal received by the optical receiver in a case where the bandpass filter illustrated in FIG. 13 is applied to the optical filter;

FIG. 15 is a block diagram illustrating a part of a configuration of the optical communication system according to the present disclosure;

FIG. 16 illustrates a spectrum of a wavelength division multiplexing (WDM) signal output from the optical filter immediately before being received by an optical reception apparatus;

FIG. 17 illustrates a spectrum of the received signal received by the optical receiver of each optical reception unit;

FIG. 18 illustrates a state in which the WDM signal is reproduced from the received signal received by each optical reception unit;

FIG. 19 illustrates an example of an optical filter setting value over the entire signal band of the WDM signal calculated by a WDM signal setting value calculation unit; and

FIG. 20 illustrates a physical configuration example of an optical filter setting unit.

### EXAMPLE EMBODIMENTS

Hereinafter, example embodiments of the present disclosure will be described in detail with reference to the drawings. In the drawings, the same or corresponding elements are denoted by the same reference numerals, and repeated description is omitted as necessary for clarity of description.

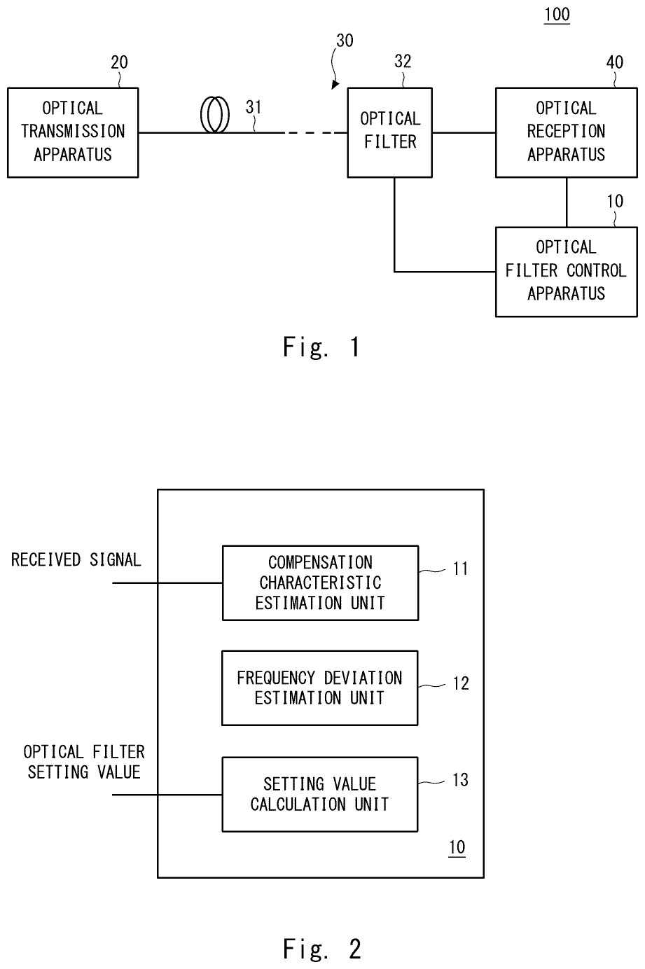

The present disclosure relates to an optical communication system that implements optimization of waveform distortion compensation for an optical signal by adjusting a frequency characteristic of an optical filter provided in an optical transmission line. Prior to describing example embodiments of the present disclosure, an outline of the present disclosure will be described. FIG. 1 schematically illustrates a communication system according to the present disclosure. An optical communication system 100 includes an optical filter control apparatus 10, an optical transmission apparatus 20, an optical transmission line 30, and an optical reception apparatus 40.

The optical transmission apparatus 20 and the optical reception apparatus 40 are connected to each other via the optical transmission line 30. The optical reception apparatus 40 receives an optical signal transmitted from the optical transmission apparatus 20 via the optical transmission line 30. The optical reception apparatus 40 extracts a received signal from the optical signal that has passed through an optical filter provided in the optical transmission line 30.

The optical transmission line 30 includes an optical fiber 31 and an optical filter 32. The optical fiber 31 guides the optical signal transmitted from the optical transmission apparatus 20. The optical filter 32 is a filter having a phase equalization function in addition to an amplitude equalization function. The optical filter 32 may be, for example, a wavelength selective switch (WSS) capable of switching an optical signal of a desired wavelength from a wavelength-multiplexed optical signal to an arbitrary path. That is, the optical filter 32 can selectively transmit an optical signal having a predetermined frequency setting value.

FIG. 2 schematically illustrates an optical filter control apparatus 10 according to the present disclosure. The optical filter control apparatus 10 includes a compensation characteristic estimation unit 11, a frequency deviation estimation unit 12, and a setting value calculation unit 13. The optical filter control apparatus 10 receives the received signal from the optical reception apparatus 40.

The compensation characteristic estimation unit 11 estimates a compensation characteristic for compensating for waveform distortion due to a transmission path of the received signal. The transmission path can include an optical transmitter 21, an optical receiver 41, and the like in addition to the optical transmission line 30. The frequency deviation estimation unit 12 estimates a frequency deviation between a frequency setting value of the optical filter 32 and a reception frequency value acquired from the received signal. The setting value calculation unit 13 calculates an optical filter setting value to be set in the optical filter by using the compensation characteristic adjusted based on the frequency deviation. The optical filter setting value set in the optical filter 32 is a frequency characteristic parameter that determines a frequency characteristic of the optical filter 32.

In the present disclosure, the waveform distortion included in the received signal can be compensated for in a light region by setting the calculated optical filter setting value in the optical filter 32. The optical reception apparatus 40 can execute equalization signal processing by digital signal processing on the received signal in which the waveform distortion has been compensated for in the light region. As described above, in the present disclosure, it is possible to reduce a load on the optical reception apparatus 40 due to the digital signal processing. Furthermore, in the present disclosure, the waveform distortion compensation for the optical signal can be optimized in the entire optical communication system including the optical filter 32 and the optical reception apparatus 40. Hereinafter, the example embodiments of the present disclosure will be described in detail with reference to the drawings.

### First Example Embodiment

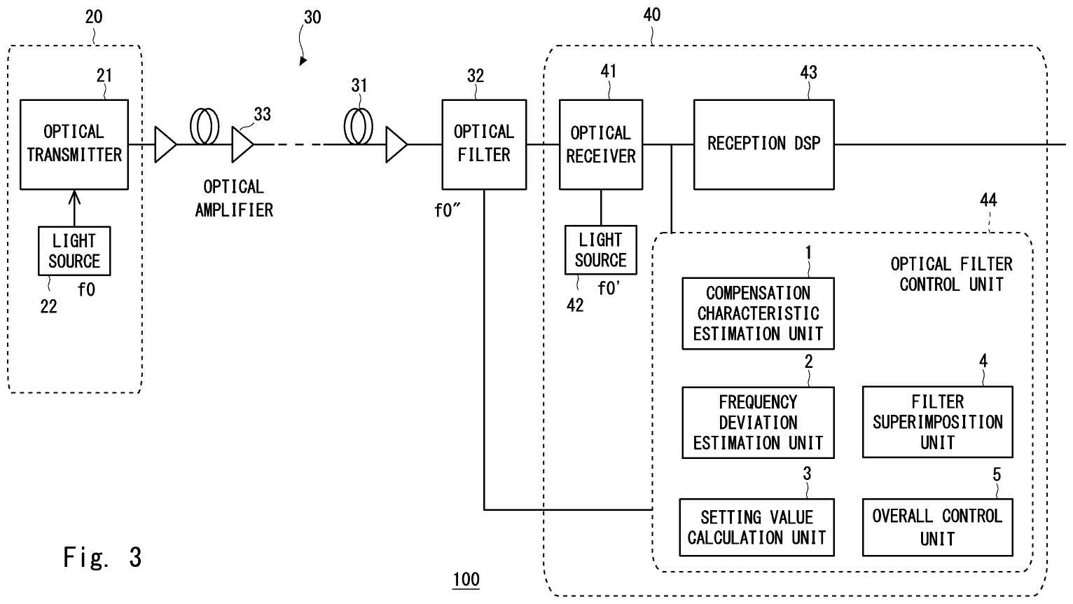

FIG. 3 is a block diagram illustrating a configuration of an optical communication system 100 according to the present disclosure. The optical communication system 100 includes an optical transmission apparatus 20, an optical transmission line 30, and an optical reception apparatus 40. The optical transmission apparatus 20 and the optical reception apparatus 40 are connected to each other via the optical transmission line 30. The optical transmission apparatus 20 converts a signal input from a client side into an optical signal and transmits the optical signal to the optical transmission line 30. The optical transmission apparatus 20 includes an optical transmitter 21 and a light source 22.

Although not illustrated here, the optical transmitter 21 may include a framer, a transmission digital signal processor (DSP), and the like. The framer contains a client signal in a transmission frame. The transmission DSP is connected to the framer. The transmission DSP may include an error correction coding processing unit, a signal mapping processing unit, a transmission spectrum shaping processing unit, a DA conversion unit, and the like.

The error correction coding processing unit executes error correction coding processing on the input transmission frame. The signal mapping processing unit maps a signal point on a constellation according to a set modulation scheme. The transmission spectrum shaping processing unit equalizes a signal analog waveform input from the signal mapping processing unit in time and frequency domains and shapes the signal analog waveform into a form suitable for transmission. The DA conversion unit converts a digital signal input from the transmission spectrum shaping processing unit into an analog electric signal and outputs the analog electric signal to the optical transmitter 21.

The light source 22 outputs continuous wave (CW) light. The light source 22 may be, for example, a laser diode. A frequency of the CW light output from the light source 22 is assumed to be f0. The optical transmitter 21 modulates the CW light output from the light source 22 according to the input analog electric signal to generate the optical signal. The optical signal generated by the optical transmitter 21 is output to the optical transmission line 30.

The optical transmission line 30 transmits the optical signal output from the optical transmission apparatus 20 to the optical reception apparatus 40. The optical transmission line 30 includes an optical fiber 31, an optical filter 32, and an optical amplifier 33. The optical fiber 31 guides the optical signal transmitted from the optical transmission apparatus 20. The optical amplifier 33 amplifies the optical signal and compensates for a propagation loss in the optical fiber 31. The optical amplifier 33 may be, for example, an erbium doped fiber amplifier (EDFA).

The optical filter 32 is a filter having a phase equalization function in addition to an amplitude equalization function. As described above, the optical filter 32 is, for example, a WSS capable of switching an optical signal of a desired wavelength from a wavelength-multiplexed optical signal to an arbitrary path. That is, the optical filter 32 can selectively transmit an optical signal having a predetermined frequency setting value. The frequency setting value of the optical filter is assumed to be f0″. The optical transmission line 30 may include a plurality of optical amplifiers 33 and a plurality of optical filters 32.

The optical reception apparatus 40 receives the optical signal and reproduces transmitted information. An optical receiver 41, a light source 42, and a reception DSP 43. The light source 42 outputs CW light that is local oscillator light. Hereinafter, the light output from the light source 42 is assumed to be reception LO light. A frequency of the reception LO light output from the light source 42 is assumed to be f0′. The optical receiver 41 performs coherent detection on the optical signal transmitted by the optical transmission line 30 using the CW light output from the light source 42, and extracts the received signal.

The reception DSP 43 is a reception processing unit that demodulates the received signal and outputs a demodulated signal. Although not illustrated here, the reception DSP 43 can include an AD conversion unit, a reception spectrum shaping processing unit, a fixed equalization processing unit, an adaptive equalization processing unit, a signal demapping processing unit, an error correction decoding processing unit, a deframer, and the like. The AD conversion unit samples the received signal output from the optical receiver 41 and converts the received signal into a digital signal. The reception spectrum shaping processing unit performs spectrum shaping of the digital signal input from the AD conversion unit.

The fixed equalization processing unit fixedly compensates for a loss occurring in the optical signal in the transmission path of the optical signal. The fixed equalization processing unit performs, for example, wavelength dispersion compensation, non-linear compensation, and the like. The fixed equalization processing unit outputs a compensated signal to the adaptive equalization processing unit.

The adaptive equalization processing unit adaptively compensates for waveform distortion occurring in the transmission path of the optical signal based on a dynamic parameter. In the reception DSP 43, at least the fixed equalization processing unit and the adaptive equalization processing unit can be implemented by hardware circuits such as a fixed equalization filter and an adaptive equalization filter.

In a case where a wavelength dispersion compensation filter is used as the fixed equalization filter, the wavelength dispersion compensation filter compensates for waveform distortion caused by, for example, wavelength dispersion of the optical fiber 31. Here, the wavelength dispersion of the optical fiber 31 is usually static unless switching of the optical fiber 31 is performed, and a distortion model is determined according to a type of the optical fiber and a transmission distance. Therefore, the wavelength dispersion compensation filter is statically handled after a filter coefficient is set according to a wavelength dispersion amount to be compensated once.

The adaptive equalization filter compensates for various types of distortion included in a signal in which waveform distortion caused by wavelength dispersion is compensated for by the fixed equalization filter. The filter coefficient of the adaptive equalization filter is adaptively updated by a coefficient update unit (not illustrated). For example, the coefficient update unit updates the filter coefficient for each sample or symbol of one time based on an input signal of the adaptive equalization filter and an output signal of the adaptive equalization filter.

The coefficient update unit calculates a difference between an output of the adaptive equalization filter and a desired state as a loss function. For example, the coefficient update unit sequentially updates the filter coefficient of the adaptive equalization filter such that the loss function is minimized. Any known algorithm used in digital coherent communication is used for coefficient update. As an adaptive equalization algorithm, a constant modulus algorithm (CMA), a decision-directed least mean square (DD-LMS), or the like can be used.

The signal demapping processing unit executes demapping processing on a signal output from the adaptive equalization processing unit to detect a symbol and convert the symbol into bit data. The error correction decoding processing unit executes error correction processing on a signal output from the signal demapping processing unit, and reproduces data encoded on a transmission side. The deframer receives decoded data, converts the decoded data into the client signal, and transmits the client signal to a client network.

As illustrated in FIG. 3, the optical reception apparatus 40 further includes an optical filter setting unit 44. The optical filter setting unit 44 implements each function of the optical filter control apparatus 10 according to the first example embodiment. The optical filter setting unit 44 includes a compensation characteristic estimation unit 1, a frequency deviation estimation unit 2, a setting value calculation unit 3, a filter superimposition unit 4, and an overall control unit 5.

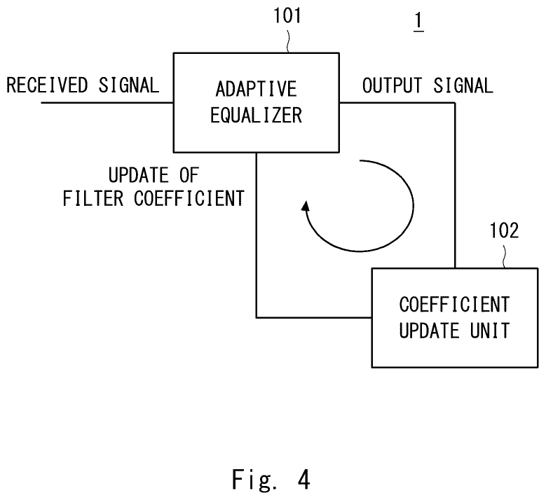

The received signal extracted from the optical signal by the optical receiver 41 is input to the compensation characteristic estimation unit 1. The compensation characteristic estimation unit 1 estimates a compensation characteristic for compensating for waveform distortion due to the transmission path of the optical signal. FIG. 4 is a diagram illustrating a configuration of the compensation characteristic estimation unit according to the present disclosure. As illustrated in FIG. 4, the compensation characteristic estimation unit 1 includes an adaptive equalizer 101 and a coefficient update unit 102.

The adaptive equalizer 101 can be an adaptive equalization filter that compensates for waveform distortion included in the received signal. The adaptive equalizer 101 can be implemented by, for example, a finite impulse response (FIR) filter, a multi input multi output (MIMO) filter, or the like.

The coefficient update unit 102 adaptively updates the filter coefficient of the adaptive equalizer 101. The coefficient update unit 102 sequentially updates the filter coefficient of the adaptive equalization filter such that a difference between an output signal of the adaptive equalizer 101 and a desired state is minimized. A filter coefficient obtained as a result of converging the output signal to the desired signal with high accuracy is a compensation characteristic (hereinafter, referred to as transmission path compensation characteristic) that most suitably compensates for a characteristic of the transmission path including the optical transmitter 21, the optical transmission line 30, the optical receiver 41, and the like. Any known algorithm used in digital coherent communication is used for coefficient update of the coefficient update unit 102. As the adaptive equalization algorithm, the CMA, the DD-LMS, or the like can be used.

In the present disclosure, the compensation characteristic estimation unit 1 executes ideal adaptive equalization processing based on the received signal and the output signal, extracts a static value from the obtained equivalent coefficient, and can set the transmission path compensation characteristic for compensating for waveform distortion due to the transmission path of the optical signal by the optical filter 32. For example, compensation for band narrowing or group delay ripple occurring in the optical fiber 31 can be offloaded from the reception DSP 43 to the optical filter 32. As a result, performance in the wavelength distortion compensation can be improved in the entire optical communication system 100. In addition, it is possible to suppress an increase in power consumption without increasing a circuit scale of the reception DSP 43.

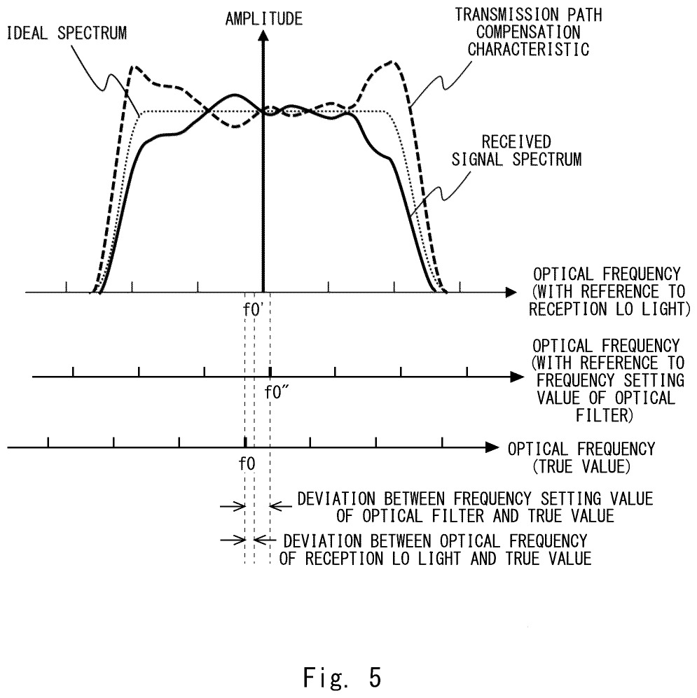

FIG. 5 illustrates an ideal spectrum of the received signal, an actually received signal spectrum, and an estimated transmission path compensation characteristic with reference to the reception LO light (frequency f0′) of the light source 42 on the reception side. In FIG. 5, a horizontal axis represents an optical frequency, and a vertical axis represents an amplitude. In FIG. 5, the light (frequency f0) of the light source 22 on the transmission side has a true value. By setting the optical filter setting value corresponding to the transmission path compensation characteristic in the optical filter 32, it is expected that waveform distortion of the received signal spectrum is compensated for and a state close to the ideal spectrum is obtained.

However, as illustrated in the lower part of FIG. 5, the frequency setting value f0″ of the optical filter 32 may deviate from the frequency f0′ of the reception LO light. In a case where the optical filter 32 is set based on the transmission path compensation characteristic as it is estimated from the received signal without considering such a frequency deviation, a characteristic deviated in an optical frequency axis direction (a left-right direction in FIG. 5) is set in the optical filter 32. As a result, compensation accuracy for the waveform distortion decreases, and there is a possibility that improvement of transmission characteristics cannot be expected.

Therefore, in the present disclosure, waveform distortion compensation with high accuracy is implemented in consideration of a difference between the frequency setting value f0″ of the optical filter 32 and the frequency f0′ of the reception LO light. The frequency deviation estimation unit 2 estimates the frequency deviation between the frequency setting value of the optical filter 32 and the reception frequency value acquired from the received signal.

The filter superimposition unit 4 generates a notch filter to be used to detect the frequency deviation, and superimposes the notch filter on the transmission path compensation characteristic. For example, the notch filter blocks an optical signal of a predetermined reference frequency of the optical filter 32 and transmits an optical signal of a frequency other than the reference frequency. That is, the filter superimposition unit 4 can also be referred to as a reference frequency setting unit.

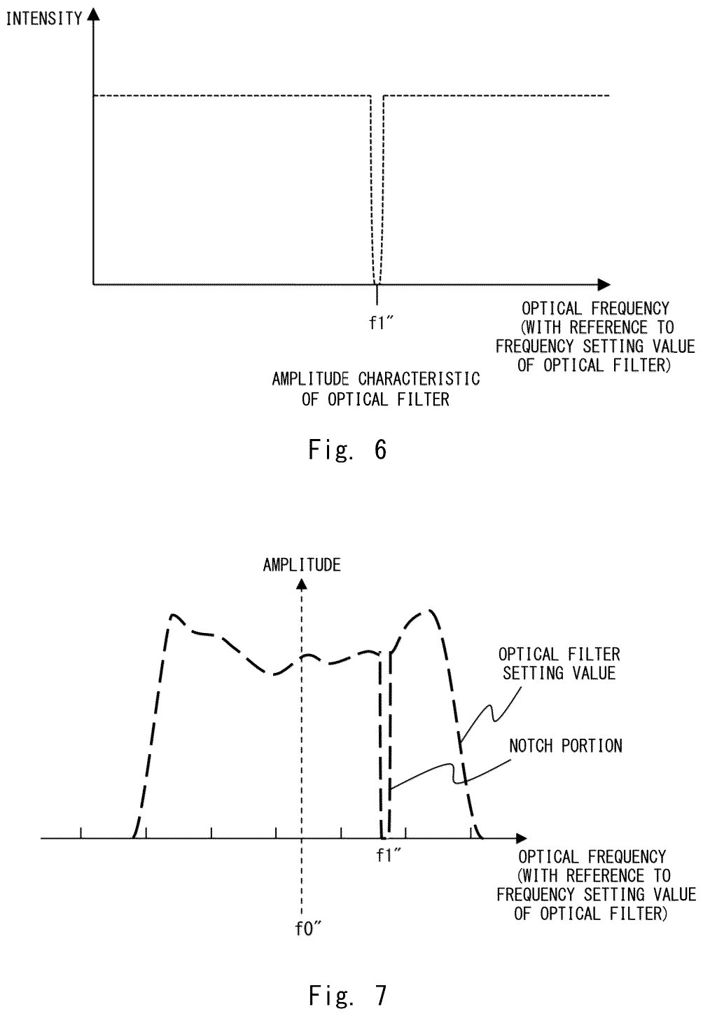

FIG. 6 illustrates an amplitude characteristic of the optical filter 32 in a case where the notch filter is applied. In FIG. 6, a horizontal axis represents an optical frequency based on the frequency setting value f0″ of the optical filter 32, and a vertical axis represents an intensity of the optical signal. In the example shown in FIG. 6, the reference frequency is set to f1″, and an optical signal of the frequency f1″ is blocked to form a notch portion.

FIG. 7 illustrates the optical filter setting value set in the optical filter 32 in a case where the notch filter is superimposed. In FIG. 7, a horizontal axis represents an optical frequency based on the frequency setting value f0″ of the optical filter 32, and a vertical axis represents an amplitude of the optical signal. As illustrated in FIG. 7, the notch portion is formed at a position corresponding to the reference frequency f1″ of the optical filter setting value of the optical filter 32.

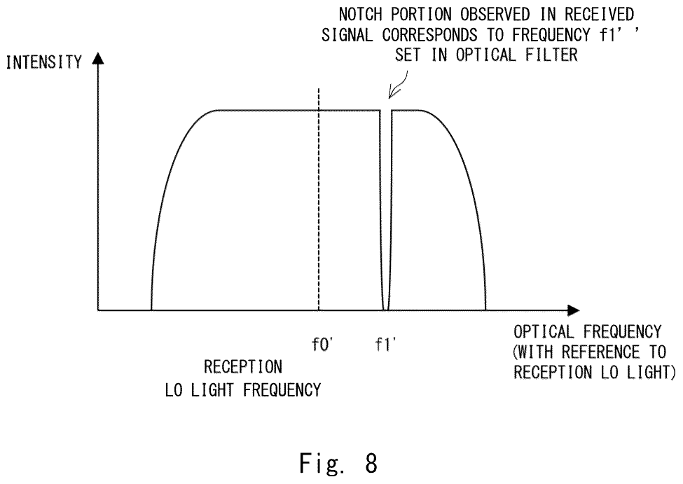

In a case where the optical filter setting value illustrated in FIG. 7 is applied to the optical filter 32, in a case where the optical signal transmitted through the optical filter 32 is received by the optical receiver 41, the notch portion is formed in the received signal. FIG. 8 illustrates the spectrum of the received signal received by the optical receiver 41. A horizontal axis represents an optical frequency with reference to the reception LO light (f0′) of the light source 42, and a vertical axis represents an intensity of the received signal. As illustrated in FIG. 8, a frequency f1′ of the notch portion observed in the received signal corresponds to the reference frequency f1″ set in the optical filter 32. It is assumed that the frequency f1′ is a corresponding frequency corresponding to the reference frequency f1″ in the received signal.

The frequency deviation estimation unit 2 can estimate a frequency deviation Δf from a difference between the reference frequency f1″ and the notch portion (corresponding frequency f1′) observed in the received signal with reference to the reception LO light. That is, the frequency deviation Δf is expressed by the following Formula (1).

$$Δ f = f {1}^{″} - f {1}^{′} \qquad ( l )$$

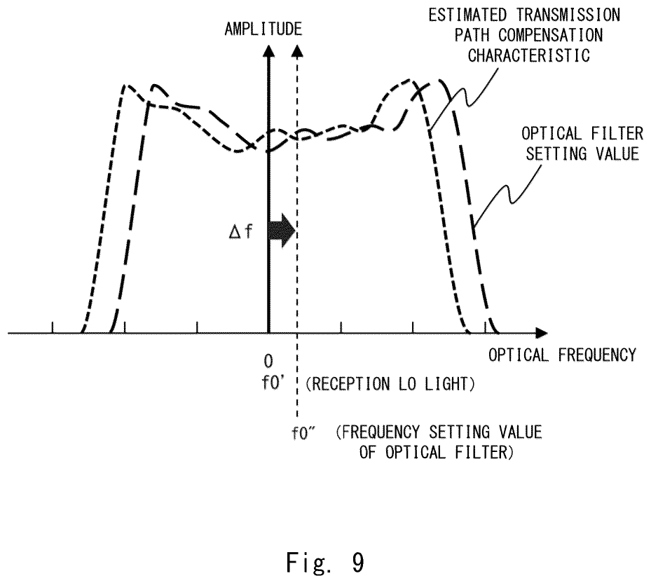

The setting value calculation unit 3 adjusts the transmission path compensation characteristic based on the frequency deviation estimated by the frequency deviation estimation unit 2, and calculates the optical filter setting value to be set in the optical filter 32 by using the adjusted transmission path compensation characteristic. FIG. 9 is a diagram illustrating adjustment based on the frequency deviation of the transmission path compensation characteristic. As illustrated in FIG. 9, the estimated transmission path compensation characteristic is shifted by the frequency deviation Δf, and the optical filter setting value to be set in the optical filter 32 is calculated.

The overall control unit 5 controls each function of the optical filter setting unit 44. For example, the overall control unit 5 can cause each functional configuration of the optical filter setting unit 44 to perform an optical reception method described below.

### (First Example of Optical Reception Method)

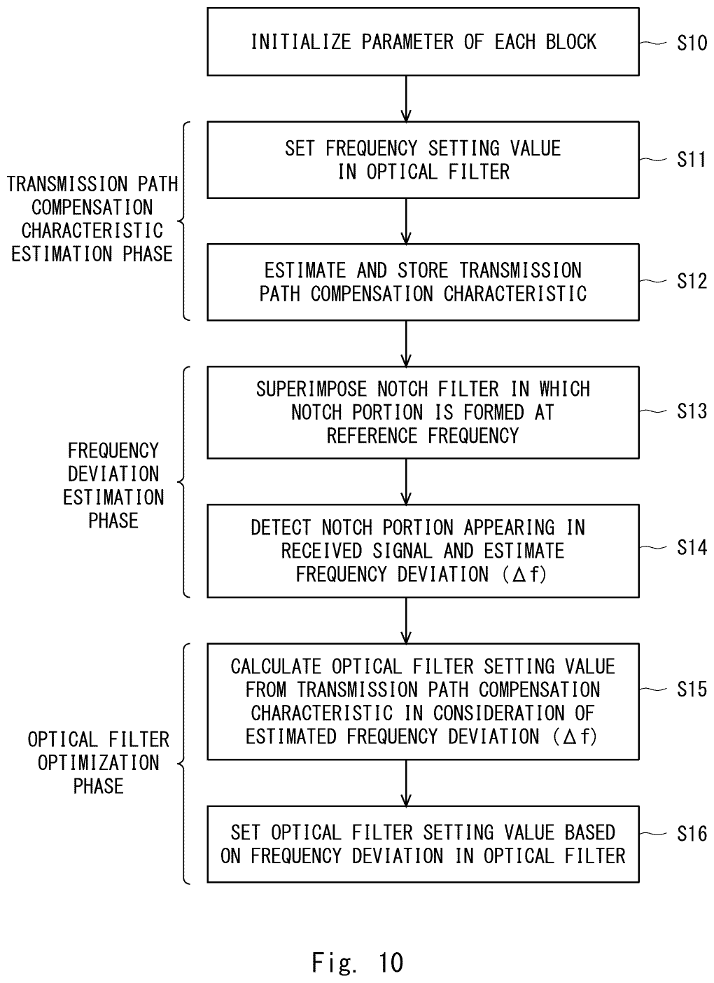

Here, the optical reception method according to the present disclosure will be described with reference to FIG. 10. FIG. 10 is a flowchart illustrating the optical reception method according to the present disclosure. The method illustrated in FIG. 10 is a flow in a case where the reference frequency of the notch filter is set within a signal band. This flow can be performed, for example, at the time of system activation.

In the example illustrated in FIG. 10, the optical reception method includes three phases of (1) a transmission path compensation characteristic estimation phase, (2) a frequency deviation estimation phase, and (3) an optical filter setting phase. First, a parameter of each block is initialized (S10). For example, the compensation characteristic estimation unit 1 does not calculate the transmission path compensation characteristic for compensating for waveform distortion from the received signal, but assumes a flat characteristic. In addition, the frequency deviation estimation unit 2 sets the frequency deviation Δf to 0 (Δf=0). Thereafter, the transmission path compensation characteristic estimation phase is performed.

In the transmission path compensation characteristic estimation phase, a predetermined frequency setting value is set in the optical filter 32 (S11). At this time, the filter superimposition unit 4 does not superimpose a characteristic of the notch filter on the frequency setting value. Then, the compensation characteristic estimation unit 1 estimates the transmission path compensation characteristic from the received signal based on the optical signal transmitted through the optical filter 32, and stores the transmission path compensation characteristic in a memory (not illustrated) or the like (S12).

In the frequency deviation estimation phase, the filter superimposition unit 4 superimposes the characteristic of the notch filter in which the notch portion is formed at the reference frequency on the predetermined frequency setting value set in the optical filter 32 (S13). Then, the frequency deviation estimation unit 2 detects the notch portion appearing in the received signal and estimates the frequency deviation (Δf) (S14). Specifically, the frequency deviation estimation unit 2 calculates, as Δf, a difference between the reference frequency set by the filter superimposition unit 4 and a frequency of the notch portion detected in the received signal. An order of the transmission path compensation characteristic estimation phase and the frequency deviation estimation phase may be reversed.

In the optical filter optimization phase, the setting value calculation unit 3 calculates the optical filter setting value from the transmission path compensation characteristic obtained in S12 in consideration of the estimated frequency deviation (Δf) (S15). Specifically, the setting value calculation unit 3 can obtain the optical filter setting value by moving the transmission path compensation characteristic in parallel in the optical frequency axis direction according to the frequency deviation (Δf).

Then, the optical filter setting value adjusted based on the frequency deviation Δf is set in the optical filter 32 (S16). Thereafter, normal optical signal reception is performed using the optical filter 32 in which the optical filter setting value is set. During the normal operation, the filter superimposition unit 4 does not superimpose the notch filter on the optical filter setting value.

As described above, according to the first example embodiment, the optical filter setting value can be calculated from the transmission path compensation characteristic estimated from the received signal in consideration of the frequency deviation between the received signal and the frequency setting value of the optical filter, so that wavelength distortion compensation can be performed with higher accuracy.

In the present disclosure, the optical filter setting unit 44 compensates for a quasi-static characteristic of the transmission path while correcting a deviation between a frequency of the light source 42 and the frequency setting value of the optical filter 32. Unlike the reception DSP 43, the optical filter setting unit 44 does not reproduce data encoded on the transmission side. Therefore, the optical filter setting unit 44 is not required to execute high-speed processing by hardware. For example, there is no restriction on a time required for the compensation characteristic estimation unit 1 to estimate the compensation characteristic, and the optical filter 32 may be controlled in units of several seconds to several days.

The optical filter setting unit 44 can be implemented as, for example, an apparatus including a processor and a memory. Some of the functions of the units in the optical filter setting unit 44 can be implemented on software by the processor executing an instruction stored in the memory. Since the compensation characteristic estimation unit 1 is implemented by software, it is possible to obtain a highly accurate compensation characteristic estimation result although it takes time. The optical filter setting unit 44 may be implemented by hardware.

### (Second Example of Optical Reception Method)

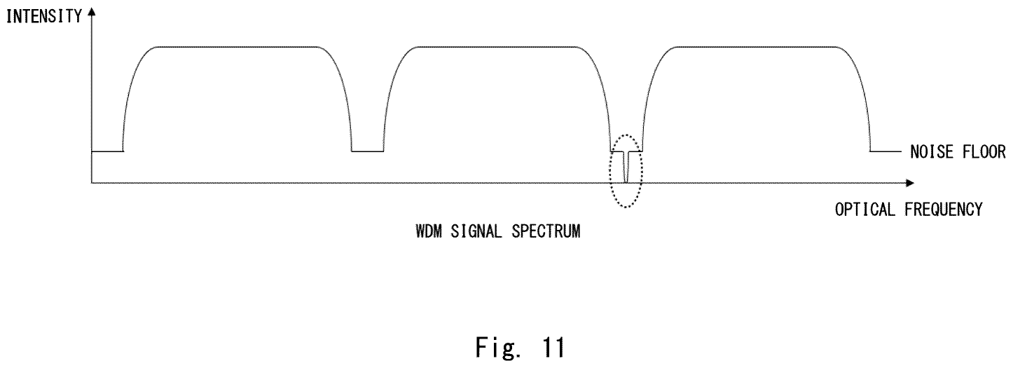

In addition, in a case where the optical signal of the reference frequency of the optical filter 32 is blocked, the filter superimposition unit 4 may set the reference frequency outside the signal band of the optical signal. For example, in a case where the signal input from the client side is a wavelength division multiplexing (WDM) signal in which a plurality of wavelengths are multiplexed, the reference frequency may be set to in guard band between adjacent signal bands in the WDM signal as illustrated in FIG. 11. That is, the notch portion can be formed in a band where the intensity of the signal is at a noise floor level.

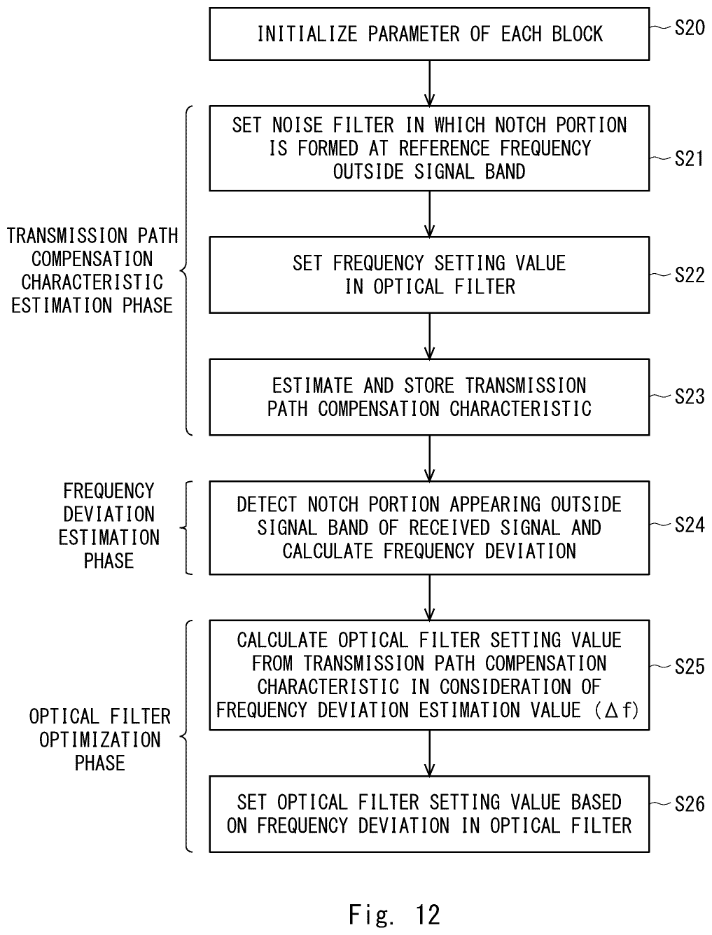

FIG. 12 is a flowchart illustrating another example of the optical reception method according to the present disclosure. The method illustrated in FIG. 12 is a flow in a case where the reference frequency of the notch filter is set outside the signal band. This flow can be applied not only in a case where the system is activated but also in a case where a normal optical signal reception operation is performed.

In the example illustrated in FIG. 12, the optical reception method includes three phases of (1) a transmission path compensation characteristic estimation phase, (2) a frequency deviation estimation phase, and (3) an optical filter setting phase. First, a parameter of each block is initialized (S20). For example, the compensation characteristic estimation unit 1 does not calculate the transmission path compensation characteristic for compensating for waveform distortion from the received signal, but assumes a flat characteristic. In addition, the frequency deviation estimation unit 2 sets the frequency deviation Δf to 0 (Δf=0).

Thereafter, the transmission path compensation characteristic estimation phase is performed. First, the filter superimposition unit 4 sets the notch filter in which the notch portion is formed at the reference frequency outside the signal band (S21). Then, a predetermined frequency setting value is set in the optical filter 32 (S22). The compensation characteristic estimation unit 1 estimates the transmission path compensation characteristic from the received signal based on the optical signal transmitted through the optical filter 32, and stores the transmission path compensation characteristic in the memory (not illustrated) or the like (S23).

In the frequency deviation estimation phase, the frequency deviation estimation unit 2 detects the notch portion appearing in the received signal and estimates the frequency deviation (Δf) (S24). Specifically, a difference between the reference frequency set by the filter superimposition unit 4 and the frequency of the notch portion detected in the received signal is calculated as Δf. An order of the transmission path compensation characteristic estimation phase and the frequency deviation estimation phase may be reversed.

In the optical filter optimization phase, the setting value calculation unit 3 calculates the optical filter setting value from the transmission path compensation characteristic obtained in S23 in consideration of the estimated frequency deviation (Δf) (S25). Then, the optical filter setting value adjusted based on the frequency deviation Δf is set in the optical filter 32 (S26).

As described above, in a case where the reference frequency is set outside the signal band of the optical signal, it is possible to estimate the frequency deviation in a case where the normal reception operation is performed. The flow illustrated in FIG. 12 may be repeatedly performed during the normal optical signal reception operation. That is, while the reception DSP 43 demodulates the received signal, a loop in which the optical filter setting unit 44 adjusts the estimated transmission line compensation characteristic based on the frequency deviation to calculate the optical filter setting value and sets the optical filter setting value in the optical filter 32 can be sequentially performed. As a result, it is also possible to cope with a variation in frequency deviation caused by environmental variation or the like.

The filter superimposition unit 4 may generate a bandpass filter (BPF) instead of the notch filter, and superimpose the bandpass filter on the transmission path compensation characteristic. The bandpass filter transmits an optical signal of a predetermined reference frequency of the optical filter 32 and attenuates an optical signal of a frequency other than the reference frequency.

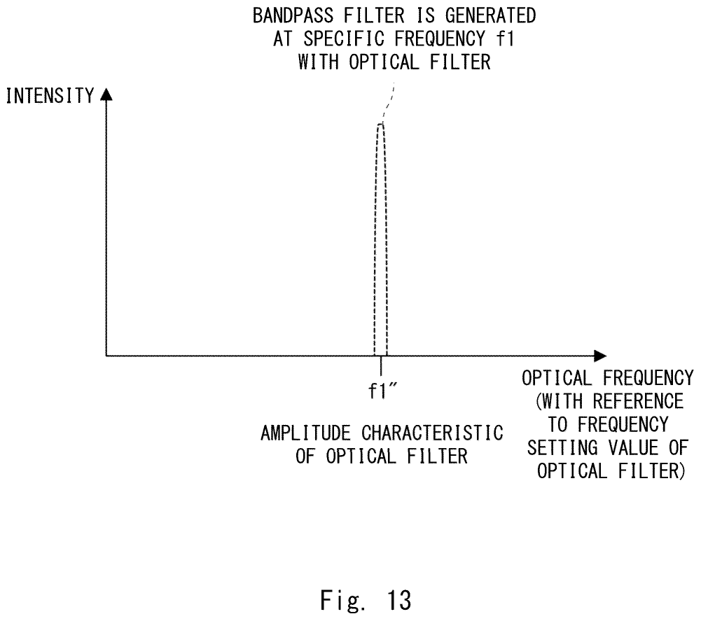

FIG. 13 illustrates an amplitude characteristic of the optical filter 32 in a case where the bandpass filter is applied. In FIG. 13, a horizontal axis represents the optical frequency based on the frequency setting value f0″ of the optical filter 32, and a vertical axis represents the intensity of the optical signal. In the example illustrated in FIG. 13, the reference frequency is set to f1″, the optical signal of the frequency f1″ is transmitted, and an optical signal of a frequency other than the frequency f1″ is blocked.

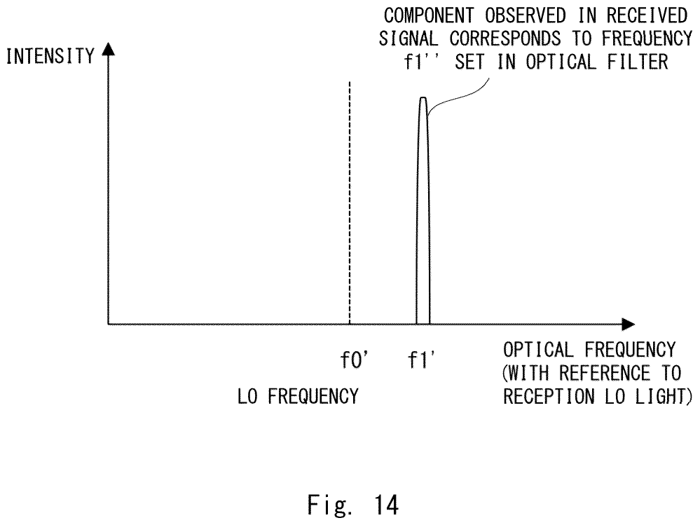

FIG. 14 illustrates a spectrum of the received signal received by the optical receiver 41 in a case where the bandpass filter illustrated in FIG. 13 is applied to the optical filter 32. A horizontal axis represents an optical frequency with reference to the reception LO light (f0′) of the light source 42, and a vertical axis represents an intensity of the received signal. As illustrated in FIG. 14, a component of the frequency f1′ observed in the received signal corresponds to the reference frequency f1″ set in the optical filter 32.

In the above description, the adaptive equalization processing unit provided in the reception DSP 43 and the compensation characteristic estimation unit 1 are separately provided, but the adaptive equalization processing unit provided in the reception DSP 43 can also be used as the compensation characteristic estimation unit 1. The optical filter setting value may be calculated using a compensation characteristic for adaptively compensating for waveform distortion occurring in the transmission path of the optical signal calculated by the adaptive equalization processing unit in the reception DSP 43.

### Second Example Embodiment

FIG. 15 is a block diagram illustrating a part of a configuration of an optical communication system 100A according to the present disclosure. The optical communication system 100A is a WDM optical transmission system using a digital coherent system. FIG. 15 illustrates an example of the optical communication system 100A that receives a 3-wave WDM signal. The optical communication system 100A includes an optical reception apparatus 40A. Although not illustrated in FIG. 15, the optical communication system 100A can include an optical transmission apparatus 20 and an optical transmission line 30 illustrated in FIG. 3.

The optical transmission apparatus 20 converts a signal input from a client side into a WDM optical signal (hereinafter, referred to as optical signal) in which a plurality of wavelengths are multiplexed, and transmits the WDM optical signal to the optical transmission line 30. The optical transmission apparatus 20 can include a plurality of optical transmitters 21 and a multiplexer. Each of the plurality of optical transmitters 21 generates coherently modulated optical signals having different wavelengths. The multiplexer performs wavelength multiplexing on the plurality of optical signals generated by the optical transmitters 21 to generate the WDM optical signal, and transmits the WDM optical signal to the optical transmission line 30. Here, the WDM optical signal includes optical signals of three channels. An optical filter 32 can transmit each of optical signals having a plurality of frequency setting values corresponding to frequencies of a plurality of channels in the WDM optical signal.

As illustrated in FIG. 15, the optical reception apparatus 40A includes a demultiplexer 50, three optical reception units (a first optical reception unit 45A, a second optical reception unit 45B, and a third optical reception unit 45C), and a WDM signal setting value calculation unit 51. The first optical reception unit 45A, the second optical reception unit 45B, and the third optical reception unit 45C are collectively referred to as an optical reception unit 45. The number of optical reception units 45 is an example, and is not limited to this example.

The demultiplexer 50 demultiplexes the WDM optical signal received from the optical fiber transmission line 103 into optical signals of a single wavelength. Each optical reception unit 45 receives the optical signal output from the demultiplexer 50 and reproduces transmitted information.

Each optical reception unit 45 may have the same configuration as the optical reception apparatus 40 illustrated in FIG. 3. That is, the optical reception apparatus 40A includes the plurality of optical reception units 45 in which an optical receiver 41, a light source 42, a reception DSP 43, a compensation characteristic estimation unit 1, a frequency deviation estimation unit 2, and a setting value calculation unit 3 are combined for each of the optical signals having the plurality of frequency setting values. It is assumed that light output from the light source 42 of the first optical reception unit 45A is reception LO1 light. It is assumed that light output from the light source 42 of the second optical reception unit 45B is reception LO2 light. It is assumed that light output from the light source 42 of the third optical reception unit 45C is reception LO3 light. In FIG. 15, a description of a filter superimposition unit 4 and an overall control unit 5 is omitted. Each optical reception unit 45 can further include the filter superimposition unit 4 and the overall control unit 5.

Each optical reception unit 45 can calculate an optical filter setting value from a transmission path compensation characteristic estimated from a received signal in consideration of a frequency deviation between the received signal and the frequency setting value of the optical filter. The function of each block of the optical receiver 41 is the same as that of the corresponding block in the first example embodiment, and a redundant description will be omitted. The WDM signal setting value calculation unit 51 calculates the optical filter setting value over the entire signal band of a wavelength division multiplexing optical signal set in the optical filter 32 by using the optical filter setting values respectively obtained by the plurality of optical reception units 45.

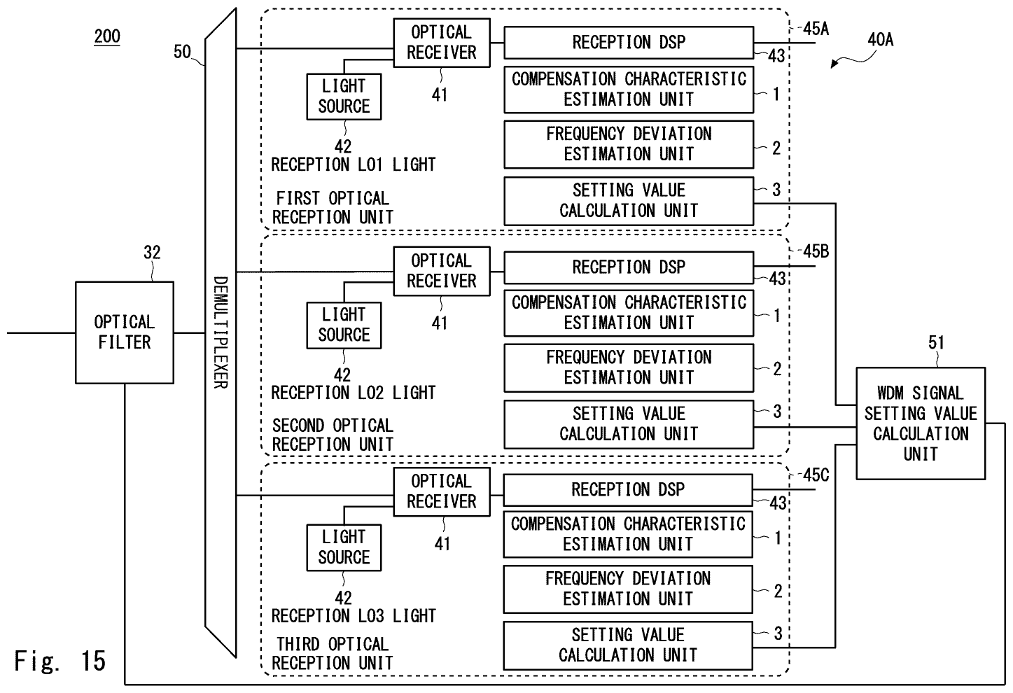

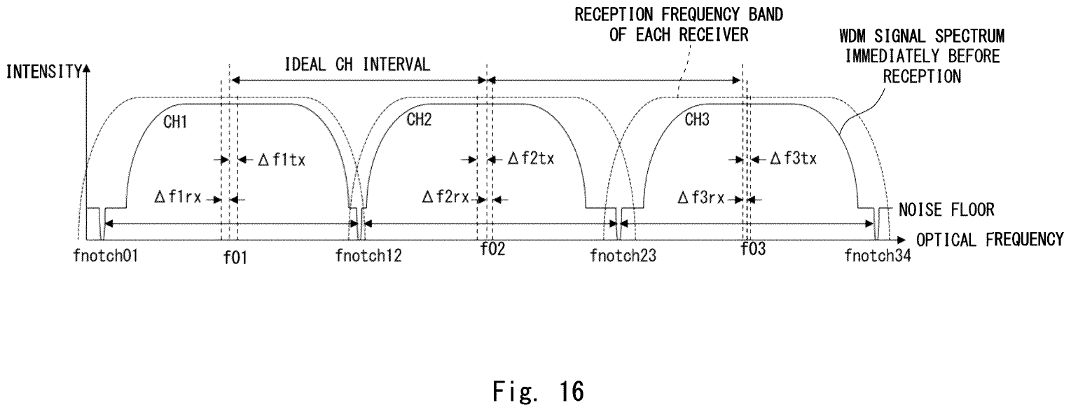

FIG. 16 illustrates a spectrum of the WDM signal output from the optical filter 32 immediately before being received by the optical reception apparatus 40A. A horizontal axis represents an optical frequency, and a vertical axis represents an intensity. Here, the WDM optical signal includes optical signals of three channels. The optical signals of the three channels are CH1, CH2, and CH3. It is assumed that frequencies (true values) of the respective channels are f01, f02, and f03. It is assumed that a reference frequency of a notch filter is set in each guard band between adjacent channels in the WDM signal. As illustrated in FIG. 16, a frequency of a notch portion on the left side of the channel CH1 is fnotch01, a frequency of a notch portion between the channels CH1 and CH2 is fnotch12, a frequency of a notch portion between the channels CH2 and CH3 is fnotch23, and a frequency of a notch portion on the right side of the channel CH3 is fnotch34.

In addition, FIG. 16 illustrates a reception frequency band of the optical receiver 41 of each of the first optical reception unit 45A, the second optical reception unit 45B, and the third optical reception unit 45C. The reception frequency band indicates a region cut out based on mixing with reception LO light (reception LO1 light, reception LO2 light, and reception LO3 light) of each optical receiver 41 and a receiver band.

As illustrated in FIG. 16, ideally, intervals between the frequencies (true values) of the respective channels are equal. However, each channel of the WDM signal has an offset on the left and right with respect to the true value due to a light source frequency offset of transmission/reception LO light and the reception LO light. The right side offsets with respect to the frequencies f01, f02, and f03 are Δf1tx, Δf2tx, and Δf3tx, respectively, and the left side offsets are Δf1rx, Δf2rx, and Δf3rx, respectively.

The reception frequency band of the optical receiver 41 of each of the first optical reception unit 45A, the second optical reception unit 45B, and the third optical reception unit 45C is wider than the signal band. Therefore, in the first optical reception unit 45A, the second optical reception unit 45B, and the third optical reception unit 45C, a valley of the spectrum by the notch filter for frequency deviation detection disposed in the guard band can be observed. That is, the reception frequency bands of two optical receivers 41 that receive adjacent channels overlap each other at a common notch portion.

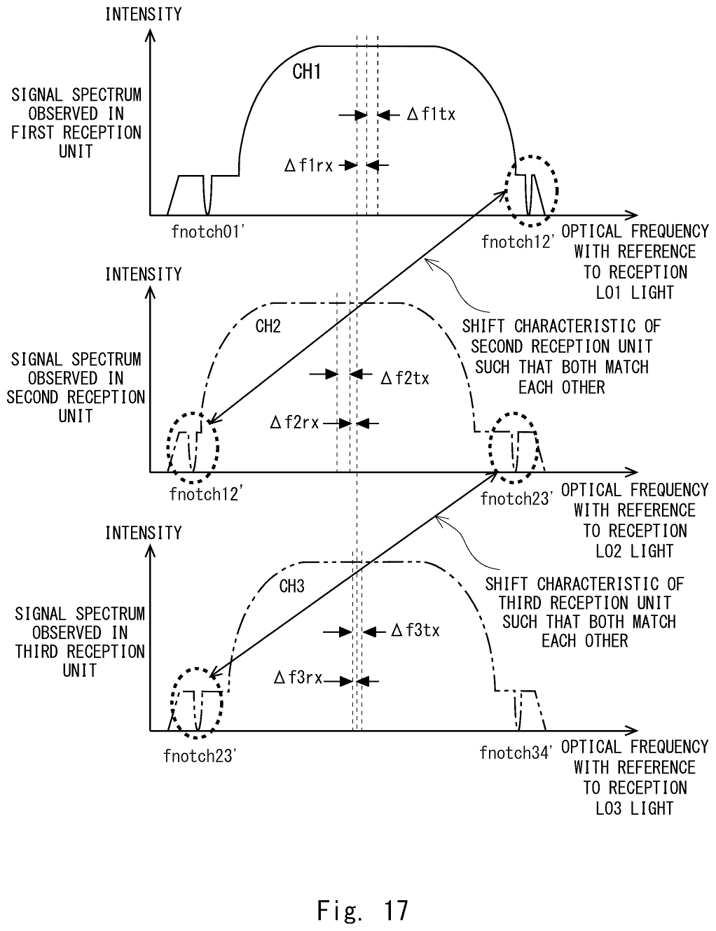

FIG. 17 illustrates a spectrum of the received signal received by the optical receiver 41 of each optical reception unit 45. A horizontal axis represents an optical frequency with reference to the reception LO light (the reception LO1 light, the reception LO2 light, and the reception LO3 light) of each light source 42, and a vertical axis represents an intensity of the received signal. A frequency f12′ of the notch portion observed in the first optical reception unit 45A corresponds to a frequency f12′ of the notch portion observed in the second optical reception unit 45B. In addition, a frequency f23′ of the notch portion observed in the second optical reception unit 45B corresponds to a frequency f23′ of the notch portion observed in the third optical reception unit 45C.

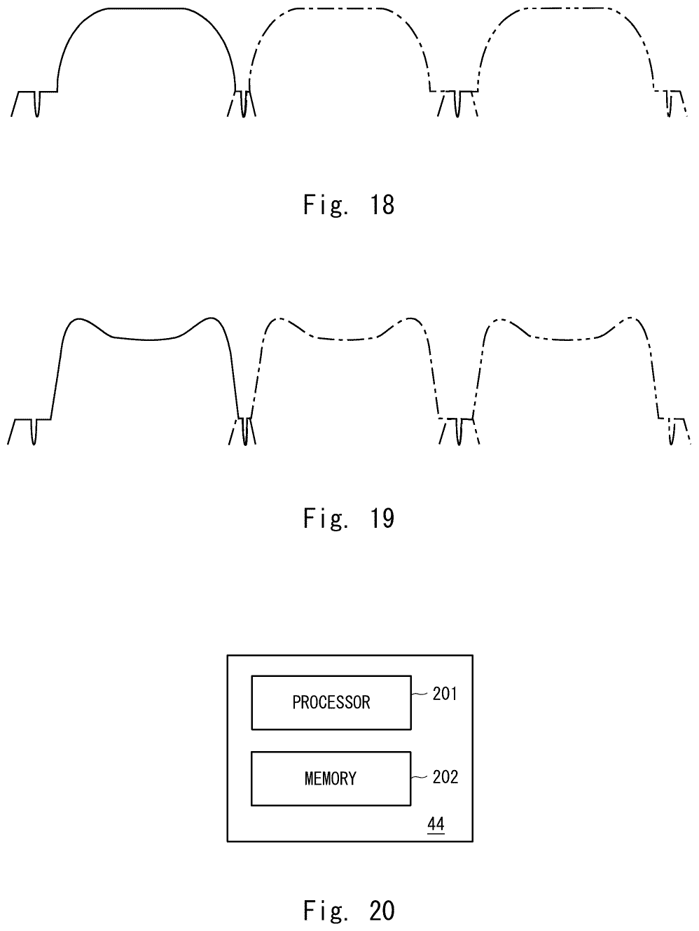

FIG. 18 illustrates a state in which the WDM signal is reproduced from the received signal received by each optical reception unit 45. It can be seen that, in a case where frequency characteristics obtained by the three optical reception units 45 are shifted and correctly arranged such that the corresponding notch portions described above match each other, a relative position of the WDM signal at a reception end can be correctly reproduced as illustrated in FIG. 18.

FIG. 19 illustrates an example of the optical filter setting value over the entire signal band of the WDM signal calculated by the WDM signal setting value calculation unit 51. Similarly to FIG. 18, by shifting and correctly arranging the transmission path compensation characteristics obtained by the compensation characteristic estimation units 1 of the respective optical reception units 45, it is possible to collectively set optical filter setting values for three waves to be set in the optical filter 32.

As described above, according to the second example embodiment, the transmission path compensation characteristics estimated by the plurality of optical reception units 45 are connected in consideration of the frequency deviation, whereby the optical filter setting value of a wide band can be calculated. As a result, the optical filter 32 can be collectively set over a wide band of the WDM signal, and filter adjustment can be simplified.

In each example embodiment described above, an example in which the light source 42 includes the optical filter setting unit 44 has been described. However, the present disclosure is not limited thereto. The optical filter setting unit 44 may be implemented as an individual apparatus independent of the optical reception apparatus 40. In other words, the optical filter setting unit 44 does not necessarily form a part of the optical reception apparatus 40, and the optical reception apparatus 40 and the optical filter setting unit 44 may be physically separate apparatuses.

In the example embodiment, the optical filter setting unit 44 can be implemented as an arbitrary digital signal processing circuit or apparatus. FIG. 20 illustrates a physical configuration example of the optical filter setting unit 44. The optical filter setting unit 44 includes one or more processors 201 and one or more memories 202. The processor 201 reads and executes a program stored in the memory 202, thereby implementing the function of each unit described above in a software manner.

A (The) program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Some or all of the above-described example embodiments may be described as in the following Supplementary Notes, but are not limited to the following Supplementary Notes.

### Supplementary Note A1

An optical filter control apparatus including:
a compensation characteristic estimation unit configured to receive a received signal extracted from an optical signal that has passed through an optical filter provided in an optical transmission line and configured to transmit the optical signal having a predetermined frequency setting value, and estimate a compensation characteristic for compensating for waveform distortion due to a transmission path of the received signal;
a frequency deviation estimation unit configured to estimate a frequency deviation between the frequency setting value and a reception frequency value acquired from the received signal; and
a setting value calculation unit configured to calculate an optical filter setting value to be set in the optical filter by using the compensation characteristic adjusted based on the frequency deviation.

### Supplementary Note A2

The optical filter control apparatus according to Supplementary Note A1, further including a reference frequency setting unit configured to block an optical signal of a predetermined reference frequency of the optical filter, and transmit an optical signal of a frequency other than the reference frequency or transmit the optical signal of the predetermined reference frequency of the optical filter, and attenuate the optical signal of the frequency other than the reference frequency if detecting the frequency deviation, in which the frequency deviation estimation unit estimates the frequency deviation based on a difference between the reference frequency and a corresponding frequency corresponding to the reference frequency in the received signal.

### Supplementary Note A3

The optical filter control apparatus according to Supplementary Note A2, in which if blocking the optical signal of the reference frequency of the optical filter, the reference frequency setting unit sets the reference frequency outside a signal band of the optical signal.

### Supplementary Note B1

An optical reception apparatus including:
an optical receiver configured to extract a received signal from an optical signal that has passed through an optical filter provided in an optical transmission line and configured to transmit the optical signal having a predetermined frequency setting value;
a compensation characteristic estimation unit configured to estimate a compensation characteristic for compensating for waveform distortion due to a transmission path of the received signal;
a frequency deviation estimation unit configured to estimate a frequency deviation between the frequency setting value and a reception frequency value acquired from the received signal; and
a setting value calculation unit configured to calculate an optical filter setting value to be set in the optical filter by using the compensation characteristic adjusted based on the frequency deviation.

### Supplementary Note B2

The optical reception apparatus according to Supplementary Note B1, in which
the optical signal is a wavelength division multiplexing optical signal,
the optical filter transmits each of optical signals having a plurality of frequency setting values, and
the optical reception apparatus includes:
a plurality of optical reception units obtained by combining the optical receiver, the compensation characteristic estimation unit, the frequency deviation estimation unit, and the setting value calculation unit for each of the optical signals having the plurality of frequency setting values; and
an overall setting value calculation unit configured to calculate an optical filter setting value over an entire signal band of the wavelength division multiplexing optical signal set in the optical filter by using the optical filter setting values respectively obtained by the plurality of optical reception units.

### Supplementary Note B3

The optical reception apparatus according to Supplementary Note B1 or B2, further including a reference frequency setting unit configured to block an optical signal of a predetermined reference frequency of the optical filter, and transmit an optical signal of a frequency other than the reference frequency or transmit the optical signal of the predetermined reference frequency of the optical filter, and attenuate the optical signal of the frequency other than the reference frequency if detecting the frequency deviation, in which the frequency deviation estimation unit estimates the frequency deviation based on a difference between the reference frequency and a corresponding frequency corresponding to the reference frequency in the received signal.

### Supplementary Note B4

The optical reception apparatus according to Supplementary Note B3, in which
the optical signal is a wavelength division multiplexing optical signal, and
the reference frequency setting unit sets the reference frequency in a guard band between adjacent signal bands in the wavelength division multiplexing optical signal if blocking the optical signal of the reference frequency of the optical filter.

### Supplementary Note B5

The optical reception apparatus according to Supplementary Note B4, further including a reception processing unit configured to demodulate the received signal and outputs a demodulated signal,
in which in a case where the reference frequency is set outside a signal band of the optical signal, while the reception processing unit demodulates the received signal, a loop in which the compensation characteristic is adjusted based on the frequency deviation, the optical filter setting value is calculated, and the optical filter setting value is set in the optical filter is sequentially performed.

### Supplementary Note B6

The optical reception apparatus according to any one of Supplementary Notes B1 to B5, further including a reception processing unit configured to demodulate the received signal and outputs a demodulated signal,
in which the compensation characteristic estimation unit is provided in the reception processing unit and is used to generate the demodulated signal.

### Supplementary Note C1

An optical transmission system including:
an optical transmission apparatus; and
an optical reception apparatus configured to receive an optical signal output from the optical transmission apparatus via an optical transmission line, in which
the optical transmission line includes an optical filter that transmits the optical signal having a frequency setting value, and
the optical reception apparatus includes:
an optical receiver configured to extract a received signal from the optical signal that has passed through the optical filter;
a compensation characteristic estimation unit configured to estimate a compensation characteristic for compensating for waveform distortion due to a transmission path of the received signal;
a frequency deviation estimation unit configured to estimate a frequency deviation between the frequency setting value and a reception frequency value acquired from the received signal; and
a setting value calculation unit configured to calculate an optical filter setting value to be set in the optical filter by using the compensation characteristic adjusted based on the frequency deviation.

### Supplementary Note D1

An optical reception method including:
extracting, by an optical receiver, a received signal from an optical signal that has passed through an optical filter provided in an optical transmission line and configured to transmit the optical signal having a predetermined frequency setting value;
estimating, by a processor, a compensation characteristic for compensating for waveform distortion due to a transmission path of the received signal;
estimating, by a frequency deviation estimation unit, a frequency deviation between the frequency setting value and a reception frequency value acquired from the received signal; and
calculating, by a setting value calculation unit, an optical filter setting value to be set in the optical filter by using the compensation characteristic adjusted based on the frequency deviation.

Some or all of the elements (for example, configurations and functions) described in Supplementary Notes A2 and A3 and Supplementary Notes B2 to B6 dependent on Supplementary Notes A1 and B1 can also be dependent on Supplementary Notes C1 and D1 by the same dependency relationship. Some or all of the elements described in any supplementary note may be applied to various types of hardware, software, recording means for recording software, systems, and methods.

What is claimed is:

1. An optical filter control apparatus comprising:
a compensation characteristic estimation unit configured to receive a received signal extracted from an optical signal that has passed through an optical filter provided in an optical transmission line and configured to transmit the optical signal having a predetermined frequency setting value, and estimate a compensation characteristic for compensating for waveform distortion due to a transmission path of the received signal;
a frequency deviation estimation unit configured to estimate a frequency deviation between the frequency setting value and a reception frequency value acquired from the received signal; and
a setting value calculation unit configured to calculate an optical filter setting value to be set in the optical filter by using the compensation characteristic adjusted based on the frequency deviation.

2. The optical filter control apparatus according to claim 1, further comprising a reference frequency setting unit configured to block an optical signal of a predetermined reference frequency of the optical filter, and transmit an optical signal of a frequency other than the reference frequency or transmit the optical signal of the predetermined reference frequency of the optical filter, and attenuate the optical signal of the frequency other than the reference frequency if detecting the frequency deviation,
wherein the frequency deviation estimation unit estimates the frequency deviation based on a difference between the reference frequency and a corresponding frequency corresponding to the reference frequency in the received signal.

3. The optical filter control apparatus according to claim 2, wherein if blocking the optical signal of the reference frequency of the optical filter, the reference frequency setting unit sets the reference frequency outside a signal band of the optical signal.

4. An optical reception apparatus comprising:
an optical receiver configured to extract a received signal from an optical signal that has passed through an optical filter provided in an optical transmission line and configured to transmit the optical signal having a predetermined frequency setting value;
a compensation characteristic estimation unit configured to estimate a compensation characteristic for compensating for waveform distortion due to a transmission path of the received signal;
a frequency deviation estimation unit configured to estimate a frequency deviation between the frequency setting value and a reception frequency value acquired from the received signal; and
a setting value calculation unit configured to calculate an optical filter setting value to be set in the optical filter by using the compensation characteristic adjusted based on the frequency deviation.

5. The optical reception apparatus according to claim 4, wherein
the optical signal is a wavelength division multiplexing optical signal,
the optical filter transmits each of optical signals having a plurality of frequency setting values, and
the optical reception apparatus comprises:
a plurality of optical reception units obtained by combining the optical receiver, the compensation characteristic estimation unit, the frequency deviation estimation unit, and the setting value calculation unit for each of the optical signals having the plurality of frequency setting values; and
an overall setting value calculation unit configured to calculate an optical filter setting value over an entire signal band of the wavelength division multiplexing optical signal set in the optical filter by using the optical filter setting values respectively obtained by the plurality of optical reception units.

6. The optical reception apparatus according to claim 4, further comprising a reference frequency setting unit configured to block an optical signal of a predetermined reference frequency of the optical filter, and transmit an optical signal of a frequency other than the reference frequency or transmit the optical signal of the predetermined reference frequency of the optical filter, and attenuate the optical signal of the frequency other than the reference frequency if detecting the frequency deviation,
wherein the frequency deviation estimation unit estimates the frequency deviation based on a difference between the reference frequency and a corresponding frequency corresponding to the reference frequency in the received signal.

7. The optical reception apparatus according to claim 6, wherein
the optical signal is a wavelength division multiplexing optical signal, and
the reference frequency setting unit sets the reference frequency in a guard band between adjacent signal bands in the wavelength division multiplexing optical signal if blocking the optical signal of the reference frequency of the optical filter.

8. The optical reception apparatus according to claim 7, further comprising a reception processing unit configured to demodulate the received signal and outputs a demodulated signal,
wherein in a case where the reference frequency is set outside a signal band of the optical signal, while the reception processing unit demodulates the received signal, a loop in which the compensation characteristic is adjusted based on the frequency deviation, the optical filter setting value is calculated, and the optical filter setting value is set in the optical filter is sequentially performed.

9. An optical reception method comprising:
extracting, by an optical receiver, a received signal from an optical signal that has passed through an optical filter provided in an optical transmission line and configured to transmit the optical signal having a predetermined frequency setting value;
estimating, by a processor, a compensation characteristic for compensating for waveform distortion due to a transmission path of the received signal;
estimating, by a frequency deviation estimation unit, a frequency deviation between the frequency setting value and a reception frequency value acquired from the received signal; and
calculating, by a setting value calculation unit, an optical filter setting value to be set in the optical filter by using the compensation characteristic adjusted based on the frequency deviation.
